(19) United States
(12) Patent Application Publication
(10) Pub. No.: US 2025/0196055 A1
(43) Pub. Date: Jun. 19, 2025

(54) PROCESS FOR CAPTURING CO2 FROM A MOBILE SOURCE USING AN AMINO ACID SOLVENT

(71) Applicant: SAUDI ARABIAN OIL COMPANY, Dhahran (SA)

(72) Inventors: Alexander Voice, Detroit, MI (US); Eric Latimer, Novi, MI (US); Esam Zaki Hamad, Dhahran (SA)

(73) Assignee: SAUDI ARABIAN OIL COMPANY, Dhahran (SA)

(21) Appl. No.: 19/068,243

(22) Filed: Mar. 3, 2025

Related U.S. Application Data
(62) Division of application No. 17/452,003, filed on Oct. 22, 2021.

(51) Int. Cl. B01D 53/14; B01D 53/18; B01D 53/62; B01D 53/78; B01D 53/92; B01D 69/02; B01D 71/06

(52) U.S. Cl. CPC B01D 53/1475; B01D 53/1425; B01D 53/185; B01D 53/62; B01D 53/78; B01D 53/92; B01D 69/02; B01D 71/06; B01D 2252/20494; B01D 2257/504; B01D 2258/01; B01D 2325/02

(57) ABSTRACT

A carbon dioxide (CO₂) capture system to reduce CO₂ emissions comprises an absorption zone and a regeneration zone. The absorption zone captures CO₂ from exhaust gas by absorption in a liquid solvent separated from the exhaust gas by a separator. The liquid solvent comprises a blend of alkali metal salts of two or more amino or amino-sulfonic acids, thereby forming a first constituent and a second constituent. The first constituent is a primary or secondary amino or amino sulfonic acid with molar mass of less than 200 g/mol. The second constituent has a molar mass of less than 300 g/mol. The regeneration zone may rejuvenate the liquid solvent rich in captured CO₂ by heating so that a resulting liquid solvent with a low concentration of CO₂ is pumped back to the absorption zone. An on-board CO₂ capture and storage system for a mobile internal combustion engine and a method for capturing CO₂ are also described.

### BACKGROUND

The transport sector is a significant contributor to global emissions of greenhouse gas, including carbon dioxide (CO₂). Although small-scale and mobile carbon dioxide capture systems for the transport sector have been proposed, the capture of CO₂ from mobile sources has generally been considered too expensive, as it involves a distributed system with a reverse economy of scale. The solution to the problem appeared to be impractical due to on-board vehicle space limitations, the additional energy and apparatus requirements, and the dynamic nature of the vehicle's operating cycle, e.g., intermittent periods of rapid acceleration and deceleration. However, as with the automobile manufacturing, mass production and automation of small-scale CO₂ capture system manufacturing processes can reduce the cost relative to one-off installations at stationary sources.

CO₂ capture from combustion gases have been focused on stationary sources, such as power plants. For instance, amine-based scrubbing is commercially available for both natural gas and coal-fired power plants, as well as industrial chemical, steel, cement, refining, and other facilities that produce CO₂ as a reaction byproduct or from thermal processes. Amine absorption, membrane separation, cryogenic separation, and adsorption are main technologies for post combustion CO₂ capture from power plant and process industry.

Amine absorption is a commonly used method in power plant and the process industry including natural gas sweetening to capture CO₂. Several advantages of amine absorption are its relative maturity, the use of lower-quality heat to drive the separation process, the partial use of thermal compression, and production of high-purity CO₂. Processes have been developed that use amines, amine functionalized materials, or other alkaline liquids and solutions to absorb CO₂ at temperatures ranging from ambient up to about 80° C. For instance, monocthanolamine (MEA), a first-generation and the most well-studied amine-based absorbent for stationary CO₂ capture, is characterized by its high chemical reactivity with CO₂, high heat of absorption, and low cost. However, it suffers from challenges with corrosion and degradation and is less reactive with CO₂ that some secondary amines. In general, primary alkanolamines, such as monoethanolamine (MEA) and diglycolamine (DGA), provide high chemical reactivity with CO₂, reducing the contact area and the size of the absorber, medium-to-low absorption capacity, and acceptable stability for stationary applications. Although MEA-based scrubbing technology is suitable for post-combustion CO₂ captured from fossil-fired plants flue gas, it suffers from several issues during operation, including high-energy requirements for stripping, moderate reaction rate of the CO₂ loaded solution, low absorption capacity, oxidative and thermal degradation, and piping corrosion. Hence, efforts have focused on the development of attractive solvents for stationary applications to achieve faster reaction rate, high absorption/desorption capacities, energy-efficient performance, and oxidative and thermal stability.

Secondary alkanolamines, such as piperazine (PZ), diethanolamine (DEA) and diisopropanolamine (DIPA), which have two carbon atoms directly bonded to the nitrogen, shows intermediate properties compared to primary amines and they are considered as an alternative to monoethanolamine (MEA). DEA is more resistant to degradation and shows lower corrosion strength than MEA, whereas DIPA has lower energy requirement for solvent regeneration than MEA. PZ is very fast reacting, and is highly stable to degradation, but has issues with solid solubility and toxicity.

Finally, tertiary amines, such as triethanolamine (TEA) or methyldiethanolamine (MDEA), are characterized by having a high equivalent weight, which causes a low absorption capacity, low reactivity, but high stability.

There are three main differences in the performance of primary and secondary amines versus tertiary amines for the CO₂ separation process. Primary and secondary amines are generally more reactive; they form carbamate by direct reaction with CO₂ (see reactions (1) and (2) below, which show carbamate formation from monoamine and a diamine carbamate, respectively).

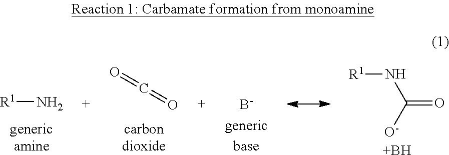

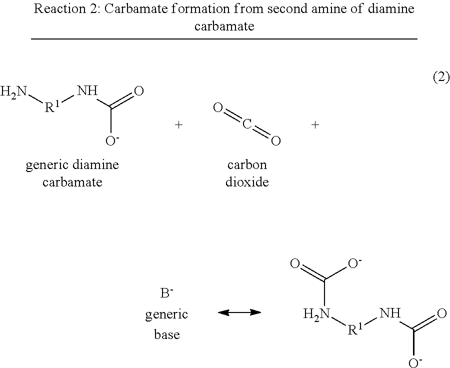

Therefore, these amines showed limited thermodynamic capacity to absorb CO₂ due to the stable carbamate formation along the absorption process, which consumes two moles of amine per mole of CO₂ absorbed. On the other hand, tertiary amines can only form a bicarbonate ion and protonated amine by the base-catalyzed hydration of CO₂ due to their lack of the necessary N—H bond. Thus, although the bicarbonate reaction is slower than the direct reaction by carbamate formation, tertiary amines show low CO₂ absorption rates. In addition, tertiary amines have high CO₂ capacity.

A significant drawback of such liquid amines is that the amines themselves, as well as their degradation products, can be volatile compounds that will be lost into the atmosphere by evaporation. In addition to the cost of replacing evaporated solvent, some of these volatile compounds entering the atmosphere may be harmful and cause secondary environmental issues-a highly undesirable outcome given that the technology is deployed to reduce its environmental impact. The risk of spills of the absorbent liquid poses a similar risk, which is exacerbated by the fact that many amine-based solvents, used for CO₂ capture, break down slowly in the environment. For this reason, amine-based solvents are less suitable for mobile carbon capture applications given their volatility, toxicity, and low environmental degradability.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a CO₂ capture system to reduce CO₂ emissions comprising an absorption zone and a regeneration zone. The absorption zone may capture CO₂ from exhaust gas by absorption in a liquid solvent separated from the exhaust gas by a porous membrane contactor or other separator. The liquid solvent may comprise a blend of alkali metal salts of two or more amino or amino-sulfonic acids, thereby forming a first constituent and a second constituent. The first constituent is a primary or secondary amino or amino sulfonic acid with molar mass of less than 200 g/mol and is present at a concentration of 2 to 5 molality (m). The second constituent has a molar mass of about less than 300 g/mol and is present at a concentration of 0.5 to 5 m. A ratio of total mols of alkali metal to total mols of carboxylate or sulfonate functional groups on the amino or amino-sulfonic acids is between 2:1 and 1:2. The total concentration of amino acid and amino sulfonic acid salts in the solution is at least 3 m and less than 10 m. A concentration of a least polar amino or amino sulfonic acid salt is less than the other salt. The regeneration zone may rejuvenate the liquid solvent rich in captured CO₂ by heating so that CO₂ from the liquid solvent is released in the gas phase and a resulting liquid solvent with a low concentration of CO₂ is pumped back to the absorption zone.

In another aspect, embodiments disclosed herein relate to an on-board CO₂ capture and storage system for a mobile internal combustion engine to reduce CO₂ emissions. The on-board CO₂ capture and storage system may comprise an absorption zone, a regeneration zone, a densification zone, and a conversion zone. The densification zone may compress the CO₂ released as a gas phase in the regeneration zone for temporary storage prior to transportation and utilization or permanent storage. The conversion zone may transform waste heat from the internal combustion engine and exhaust system into power for the CO₂ capture and storage system.

In another aspect, embodiments disclosed herein relate to a method of capturing CO₂, comprising separating CO₂ from exhaust gas by absorption in a liquid solvent separated from the exhaust gas by a porous membrane contactor or other separator. The liquid solvent comprises a blend of alkali metal salts of two or more amino or amino-sulfonic acids, thereby forming a first constituent and a second constituent. The first constituent is a primary or secondary amino or amino sulfonic acid with molar mass of less than 200 g/mol and is present at a concentration of 2 to 5 molality (m). The second constituent has a molar mass of about less than 300 g/mol and is present at a concentration of 0.5 to 5 m. The total concentration of amino acid and amino sulfonic acid salts in the solution is at least 3 m and less than 10 m.

Other aspects and advantages of this disclosure will be apparent from the following description made with reference to the accompanying drawings and the appended claims.

### BRIEF DESCRIPTION OF DRAWINGS

FIG. 1 depicts a process flow of one or more embodiments.

FIG. 2 shows an overview of the system.

FIG. 3 shows a diagram of the CO₂ separation process.

FIG. 4 shows an example of the CO₂ capture system according to one of more embodiments.

FIG. 5 describes a schematic of the CO₂ absorption process.

FIG. 6 depicts a schematic view of the solvent regeneration process.

FIGS. 7A-7C depicts a schematic view of the solvent/membrane/gas interfaces with a highly polar solvent on the left and a less polar solvent on the right.

FIG. 8 shows the gas bubbler used for solubility testing.

FIG. 9 shows a diagram of the specific heat rates for regeneration of selected amino sulfonic acid blends, traditional amines, and amine blends as a function of regeneration pressure.

FIG. 10 is a diagram of the percentage of CO₂ capture rates for selected amino sulfonic acid blends, traditional amines, and amine blends as a function of regeneration pressure.

### DETAILED DESCRIPTION

Embodiments disclosed herein generally relate to solvent capturing agents used in CO₂ capture and storage unit for internal combustion engines to maximize the system performance while minimizing size, cost, and secondary environmental impacts. A post-combustion CO₂ capture system may be in the engine exhaust stream and can capture the emitted CO₂ with minimal energy penalty by integration of the heating, cooling, and power systems. The present disclosure is directed to a thermally stable, high capacity, non-toxic, low-viscosity, high surface-tension, high ionic strength, non-volatile, fully soluble, and fast reacting solvent capturing agent that advantageously allow for a continuous operation of the CO₂ capture system that may rely upon the heat generated by the engine itself.

In particular, the heat of the engine, specifically the waste heat, may be a source of energy for a CO₂ capturing system. Heat is emitted and lost by convection and radiation from the engine block and its associated components through which the exhaust gas passes, including the manifold, pipes, catalytic converter, and muffler. This heat energy totals about 25-50% of the chemical potential energy available via combustion that typical hydrocarbon (HC) fuels provide. Therefore, the use of exhaust enthalpy to provide the energy for CO₂ capturing solvent, regeneration (and CO₂ release), and densification reduce the energy capturing cost significantly. Densification reduces the volume requirement for temporary on-board storage of the CO₂. Converting part of the exhaust enthalpy into electrical or other useable forms of energy also reduces the parasitic load associated with operating the CO₂ compression and solvent circulation equipment, and thereby improves the overall system efficiency.

One or more embodiments of the present disclosure relate to a CO₂ capturing material from a mobile source, such as a car, a truck, a bus, a ship, or a train. Mobile vehicles with one or more embodiments of the exhaust gas carbon dioxide capture and recovery systems are not limited to vehicles or vessels that are self-propelled. Embodiments of the exhaust gas carbon dioxide capture and recovery system may also be mounted on mobile yet non-self-propelled vehicles and vessels, such as a towed barge, a land-or water-borne skiff, or a land-or water-borne drilling platform or “rig”, a generator, or any other engine, turbine, or other equipment producing a hot exhaust stream containing CO₂. The mobile unit is configured to be moved and to supply an exhaust stream to the exhaust gas CO₂ capturing and recovery system for concentrated pressurized CO₂ recovery.

It is envisioned that the CO₂ capturing system and apparatus can be retrofitted to existing mobile sources. Various components of the capturing system may be integrated into a mobile source to form an efficient post combustion CO₂ capture, densification, and subsequent temporary on-board storage using waste heat recovered from the internal combustion engine.

Embodiments of the present disclosure are directed to a solvent capture agent that absorbs CO₂ from an exhaust gas and subsequently releases the CO₂ by heating the solvent capturing agent rich in CO₂, thereby continuously regenerating the solvent capturing agent to subsequent absorption of CO₂. One or more embodiments may advantageously use waste heat from an internal combustion engine generating the exhaust and CO₂. In one or more embodiments, the CO₂ solvent capturing agent includes at least two amino acids, a primary or secondary amino or amino sulfonic acid with molar mass of less than 200 g/mol. In one or more embodiments, the CO₂ solvent capturing agent includes a combination of taurine and homotaurine, having advantageous synergism effects. Embodiments of the present disclosure are directed to a solvent blend that achieves a CO₂ capturing rate of at least 40% with a solvent regeneration heat rate of less than 6 MJ/kg of CO₂.

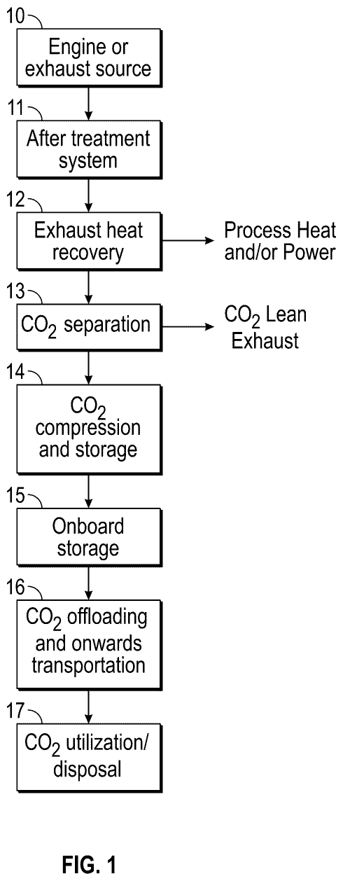

Referring to FIG. 1, an overview of the CO₂ capture process for an internal combustion engine is now described. At stage 10, an exhaust gas from the internal combustion engine contains carbon dioxide (CO₂), water, unburned hydrocarbons (HC), nitrogen oxide (NOₓ), and other impurities, and then passes through an aftertreatment system at stage 11. The exhaust gas may initially have a temperature from 200° C. to 800° C. after exiting the engine and passing through the aftertreatment system. The exhaust gas then passes to a heat recovery stage 12, which reduces the temperature of the exhaust gas to temperatures between 20° C. and 80° C. (and recovers part of the exhaust heat for use in the process). Then, at the CO₂ separation stage 13, the exhaust gas enters a CO₂ absorption zone of the capturing system. In stage 13, the exhaust gas is first contacted with a liquid solvent capturing agent across a liquid gas contactor, such as a porous membrane, wherein small pores allow gas to permeate through the membrane, but liquid cannot diffuse through due to the pore size and capillary pressure. During this stage, a CO₂-lean liquid solvent capturing agent absorbs CO₂ from the exhaust gas, thereby separating the CO₂ from the engine exhaust gas to form a CO₂-lean exhaust and a CO₂-rich solvent.

Still in the CO₂ separation stage 13, the CO₂-rich solvent then enters a regeneration zone where CO₂ is released from the liquid solvent capturing agent (for example, using the exhaust heat). Specifically, CO₂ and water are boiled off from the CO₂-rich solvent in the regeneration zone typically at elevated temperature and pressure. Then, at stage 14, the CO₂ released from the liquid solvent capturing agent enters the densification zone to be compressed, and at stage 15, the compressed CO₂ is stored on-board in the on-board storage. The stored CO₂ is then transferred to an offloading location in a CO₂ offloading and transportation stage 16. Finally, the offloaded CO₂ will be disposed of, using for example permanent geological storage, or utilized for different applications in a CO₂ utilization and disposal stage 17.

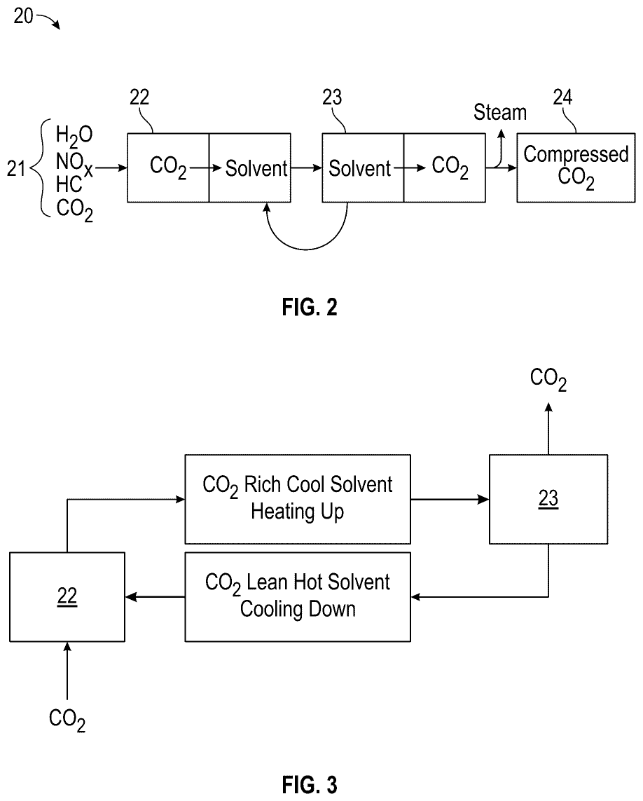

Referring now to FIG. 2, a CO₂ capturing system 20 in which the liquid solvent capture agent of the present disclosure may be used is depicted, while FIG. 3 shows a diagram of the CO₂ separation process. The major constituents of exhaust gas are nitrogen (N₂), CO₂, water (H₂O), and oxygen (O₂). The minor constituents include sulfur dioxide (SO₂), nitrogen oxides (NOₓ), carbon monoxide (CO), unburned hydrocarbons (HC), and particulate matter (PM). As shown in FIGS. 2 and 3, exhaust gas 21 enters the CO₂ capturing system 20 in an absorption zone 22. In the absorption zone 22, exhaust gas 21 is contacted with a liquid solvent capture agent, across a liquid gas contactor, such as by direct contact. In one or more embodiments, the liquid gas contactor operates at a temperature ranging from 20 to 80° C. and the exhaust gas enters at around atmospheric pressure (90-110 kPa). Examples of the gas liquid contactor that may be used in one or more embodiments include a packed column, membrane-type contactor or rotating packed bed contactor. In a membrane contactor, the pressure on the gas and liquid side of the contactor may be different, for example, the liquid side may have a pressure of 1-5 bar absolute, although more typically 1-1.5 bar. The pressure of the liquid side depends on various operating parameters and properties of the solution. For example, more viscous liquids will have higher pressure drop in the contactor and therefore require higher pressure at the inlet to achieve the desired flow rate. Operating the liquid side of the membrane contactor at higher pressure also reduces the pressure difference between the absorber and stripper, thus reducing solvent pumping work. On the other hand, the pressure difference between the gas and liquid side is limited by the capillary pressure, which depends on the pore dimensions and the liquid surface tension. If the pressure on the liquid side is too high, it can force liquid into the pore space lengthening the CO₂ diffusion path and decreasing overall CO₂ absorption rate. If the pressure exceeds the capillary pressure, liquid seepage into the gas will occur leading to undesirable loss of solvent with the exhaust gas into the environment. Referring now to FIG. 3, a CO₂-lean liquid solvent absorbs CO₂ from the exhaust gas in the absorption zone 22, thereby separating the CO₂ for subsequent capture of CO₂ from the engine exhaust gas to form a CO₂-rich solvent. The lean loading may range from about 0.15 mol CO₂ per mol of alkalinity to about 0.45 mol CO₂ per mol of alkalinity, whereas the rich loading may vary from about 0.25 mol CO₂ per mol of alkalinity to about 0.5 mol CO₂ per mol of alkalinity.

The CO₂-rich solvent then enters a regeneration zone 23 where CO₂ is released from the liquid solvent capture agent. In particular, CO₂ and water are boiled off from the CO₂-rich solvent in regeneration zone 23. The regeneration zone 23 may operate at a temperature ranging from 90° C. to 150° C., such as 110-125° C., and a pressure ranging from 1 bar to 20 bar absolute, such as 1.2-5 bar absolute. Steam may be condensed out of the gas stream while the now captured CO₂ enters densification zone 24 (in FIG. 2) where the CO₂ is compressed to a pressure in between 1 and 150 bar for storage or utilization. Advantageously, the energy for operating system 20 may come from the waste heat of the internal combustion engine, for example by use of exhaust gases in the solvent reboiler, or through use of a secondary steam loop to first produce steam from the exhaust gas, and then use of that steam to provide heat to the solvent reboiler.

As mentioned above, heat from the engine may be used in the regeneration zone 23 and densification zone 24 (in FIG. 2). The waste heat that a typical engine produces consists mainly of hot exhaust gases (200° C. to 800° C.) and hot coolant (80° C. to 120° C.). As mentioned above, this heat energy totals about 25-50% of the energy that typical hydrocarbon fuels produce upon combustion in an internal combustion engine. Energy is needed to separate the CO₂ from the exhaust gases and to compress, liquefy or freeze all or part of the captured CO₂ for efficient on-board storage. This energy is typically a mix of work and heat energies. The work component of the energy can be generated by using part of the waste heat to produce this work. Some waste heat can be used to regenerate any material used in the CO₂ separation such as absorbent or a solid carbonate that is formed as a reaction product, and reduce the work required through the use of thermal compression by operating the stripper at elevated pressure.

For example, heat from the exhaust gas 21 may be provided directly to the regeneration zone 23 via heat exchange surfaces (not shown) inside the regeneration zone 23, or indirectly by use of the exhaust gas 21 to produce steam, which is then fed to the regeneration zone 23. The hot exhaust gas may also optionally heat the hot CO₂-rich solvent (prior to the exhaust gas being cooled to enter absorption zone 22). Further, it is also envisioned that some of the waste heat may be converted into power (work energy) for use within the system. It is also envisioned that heat from other streams connected to the engine (such as an exhaust gas recirculation stream, engine coolant, or engine lubrication oil) may also be used within the system 20, such as to regenerate solvent in regeneration zone 23.

Thus, as illustrated, system 20 may operate continuously to capture CO₂ from exhaust gas 21 using a solvent capture agent that is continuously regenerated using waste heat from the internal combustion engine. Selection of a liquid solvent capture agent that may be suitable for use in such system may involve balancing factors such as high CO₂ mass transfer, high heat of absorption, high cyclic capacity, low viscosity, high solid solubility, low solvent toxicity, low process degradation rates, low volatility, and high environmental degradability in case of accidental release. These properties will impact the equipment size and cost, the system performance, and the overall feasibility of the process. In one or more embodiments, the CO₂ capturing agent includes at least two amino acids, a combination of salts of at least one amino sulfonic acid and at least one other amino or amino sulfonic acid, which may have an advantageous synergism when used in combination. The amino sulfonic acid salt is defined as a molecule containing a nitrogen group and sulfonic acid functional group (in place of a carboxylic functional group for an amino acid), wherein at least part of the acid functional group has been neutralized with an alkali metal comprising sodium, potassium, or lithium. The liquid solvent capture agent may have a ratio of total alkali metal (such as potassium) to total carboxylate and/or sulfonate functional groups on the amino and/or amino sulfonic acids that is between 2:1and 1:2. The liquid solvent capture agent has a first constituent, which is a primary or secondary amino or amino sulfonic acid with molar mass of less than 200 g/mol. The first amino acid is present at a concentration of 2 to 5 molality (m). Any additional amino or amino sulfonic acids are present at a concentration of 0.5 to 5 m, wherein the additional amino or amino sulfonic acids have a molar mass of about less than 300 g/mol. The total concentration of amino acid and amino sulfonic acid salts in the solution (of water) is at least 3 m and less than 10 m. This liquid solvent capture agent solution may have a viscosity of less than 10 cP at 40° C. and a pH, prior to CO₂ capture, between 8 and 12. However, when the liquid solvent capture agent is loaded with CO₂, its pH may be between 9 and 11. The concentration of the least polar (among all amino acid or amino sulfonic acids present) amino acid salt constituent may be lower than the other constituents in order to maximize surface tension, increase contact angle between the solvent and the membrane material, reduce pore wetting in a hydrophobic membrane contactor (such as those made of polypropylene, PTFE, PEEK, or other hydrophobic polymers), and maximize CO₂ mass transfer rates under a given set of conditions. In one or more particular embodiments, the amount of the least polar amino acid salt constituent may be selected to be as low as possible while maintaining a fully soluble solution in the process (i.e. under typical CO₂ loading conditions).

The volumetric flow rate of the exhaust gas that can effectively be treated to remove or reduce the CO₂ present may fall in any range. However, the size of the contactor and other operating parameters such as lean loading and solvent circulation rate should be adjusted to achieve the desired capture rate and optimal performance. For example, the ratio of exhaust gas mass to solvent mass rate may range from about 1 to 8 kg solvent per kg gas treated. The solvent rate may be optimized based on the CO₂ concentration, the capture rate, and the lean loading for a particular application. Higher solvent rates will enable higher lean loadings, higher stripper pressure (and incumbent lower energy for compression), and less water vaporized per mol of CO₂ released. However higher solvent circulation rates also increase pump work, require larger equipment, and increases sensible heat requirements to heat the incoming solvent to the temperature of the regenerator. The CO₂ concentration in the exhaust gas may range, for example, from 0.03 to 15 mol. % at the absorber inlet, or from a lower limit of any of 0.03, 0.1, 0.5, or 1.0 mol. % to an upper limit of any of 5, 10, or 15 mol. %, where any lower limit can be used by any upper limit.

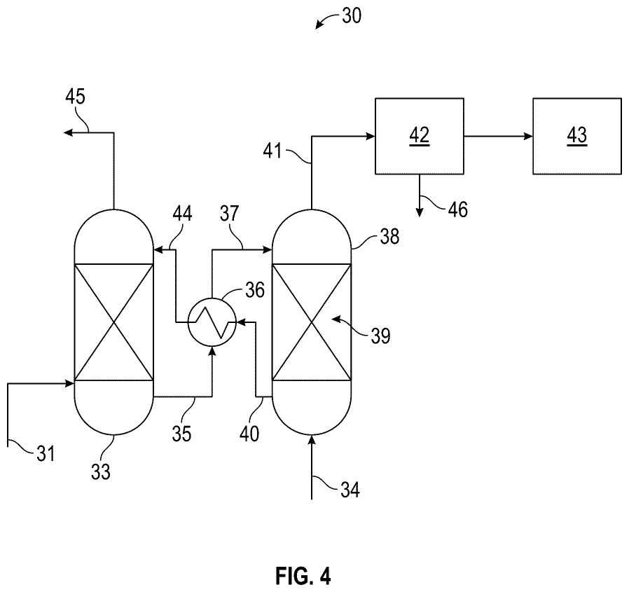

Referring now to FIG. 4, a specific example of a CO₂ capturing system 30 that may be used in the implementation of the process described in FIG. 1 is shown. Exhaust gases (containing CO₂) 31 are fed to an absorber 33, which may provide for interaction of the exhaust gases 31 with a CO₂-lean solvent 44 for absorption of CO₂. Following absorption of at least a portion of the carbon dioxide, the exhaust gases having a reduced carbon dioxide content may be recovered from the absorber 33 via flow line 45. The CO₂-lean solvent 44 may be fed at a top of the absorber 33 and a CO₂-rich solvent 35 may be recovered from a bottom of the absorber 33. The CO₂-rich solvent 35 may then be forwarded to a stripper 38 for conducting a desorption step.

In stripper 38, the CO₂-rich solvent may be heated to diminish its capacity for retaining carbon dioxide in a dissolved state. Stripper 38 may contain a bed of contact structures 39 providing for contact of hot vapors with the CO₂-rich solvent 35, aiding in the removal of carbon dioxide from the solvent. Heat input(s) 34 may be provided from various sources, such as from exhaust gases, a stand-alone boiler, electrical power generated by the engine, or other heat sources available from the engine. The heat input 34 may strip carbon dioxide from the solvent due to the equilibrium constant for reactions 1 and 2, which favor the reverse reaction at higher temperature. This allows recovery of a carbon dioxide and water vapor stream 41 from a top of the stripper 38 and recovery of a hot CO₂-lean solvent 40 from a bottom of the stripper 38. Due to the heat addition to the solvent during stripping, the CO₂-lean solvent 40 recovered from the stripper has an elevated temperature and thus has a diminished capacity for retaining carbon dioxide because of the reversibility of reaction 1 and 2, and favorability of the reverse reaction at higher temperature. A feed/effluent exchanger 36 may be used to cool the hot lean solvent 40 (thereby forming cool CO₂-lean solvent 44) while warming (pre-heating) the CO₂-rich solvent 35 being fed from the absorber 33 to the stripper 38. Optionally (not shown), the cool CO₂-lean solvent 44 may also pass through a trim cooler to further cool the solvent 44 to the temperature of the absorber 33. In some embodiments, the hot-side approach temperature of the solvent cross exchanger 36 may be around 7-15° C., and the cold-side approach temperature of the solvent cross exchanger 36 may be around 3-10° C.

The carbon dioxide 41 recovered from the stripper 38 may undergo downstream processing as noted above, including compression/liquefaction at densification zone 42, removal of water 46, and storage at storage unit 43, among others. Specifically, CO₂ gas may be compressed to a pressure of 1 to 150 bar for storage or utilization. CO₂ utilized onsite for ambient pressure applications may not require further compression, whereas CO₂ being transported offsite may require compression to densify the material. The treated exhaust gas stream having a reduced CO₂ content may be discharged into the atmosphere. The formation of dense CO₂ for efficient on-board temporary storage 33 may be accomplished by compression, liquefaction, or by freezing the gas to form solid CO₂, i.e., dry ice. The final density of the CO₂ may be in the range of 40-1600 kg/m³, depending upon its state final temperature and pressure.

The storage unit 43 may include onboard storage. The specific use in the limited space that can be made available on-board mobile sources may involve analysis of many parameters. As mentioned above, a packed column, a membrane-type contactor or a rotating packed bed contactor are examples of the gas liquid contactor used to extract CO₂ from the hot CO₂-rich capturing solvent 35. Regeneration of the solvent capturing agent may take place on board the mobile source by a temperature swing process. In a thermal-swing absorption cycle, the cooled exhaust gases 31 are passed through the absorber 33, where CO₂ is absorbed into the CO₂-lean liquid solvent capturing agent 44 (thereby forming the CO₂-rich solvent 35), and the remaining gases, the CO₂-lean exhaust gas 45, are released into the environment. The hot CO₂-rich solvent 35 becomes the hot CO₂-lean solvent 40 after CO₂ extraction. Circulation of the solvent occurs continuously so that the solvent is never saturated.

Additional details of such system may be found in U.S. Patent Application entitled “Process for Capturing CO₂ from an Internal Combustion Engine Source Utilizing Multiple Sources of Waste Heat”, filed concurrently herewith and which is incorporated by reference in its entirety. However, it is also intended that the presently described liquid solvent capturing agent may be used in other CO₂ capture system as well.

As mentioned above, a mobile CO₂ capturing system may be defined as a system to reduce CO₂ emissions of an internal combustion engine in a car, or a truck, or a boat, or an airplane, or similar transportation vehicle emitting CO₂. Further, the on-board CO₂ capturing system may be inside or close by the engine compartment and, or alternatively, towed by a barge by a boat for instance. One advantage of mobile applications for reducing CO₂ emissions over stationary applications is the availability of a large amount of relatively high to moderate temperature waste heat, which may be used to perform solvent regeneration, thereby allowing the continuous CO₂ absorption/capture, solvent regeneration, as well as CO₂ densification. The cost of the heat energy is a major expense for CO₂ capture in stationary applications because the temperature of the flue gases from a coal- or gas-fired electrical generation facility has been reduced using large equipment in order to maximize the conversion of heat to power. Steam used for solvent regeneration in these systems is taken from the inlet to the low-pressure turbine, reducing the plants power output by 30% or more. In mobile applications, at least a part of the total work energy required for the densification may be obtained from the waste heat by using heat-to-power conversion, as well as from thermal compression using available waste heat. Typical hot exhaust gases 21 from internal combustion engine vary in temperature depending on the frequency of engine rotation, load, and location along the exhaust system/pipe. The temperature may range from 200° C. to 850° C. To cool down these gases and at the same time provide power or work energy for later CO₂ densification, the hot exhaust gas stream 21 may be passed through an exhaust turbine to generate mechanical work or electricity, a thermoelectric device or other heat to power converter. The power from the converter can be used to densify CO₂ via a compressor.

However, it is also envisioned that the solvent blend may be used in other thermal-swing absorption CO₂ capturing systems that use different gas-liquid contacting devices, heat transfer devices, configurations of process equipment, and operating conditions, which are designed to remove CO₂ from gas streams not produced from internal combustion engines—such as power plants, cement kilns, steel mills, refineries, chemical plants, fermentation facilities, and other stationary large scale industrial facilities producing gas streams containing CO₂, as well as direct air capturing systems designed to remove CO₂ from the atmosphere.

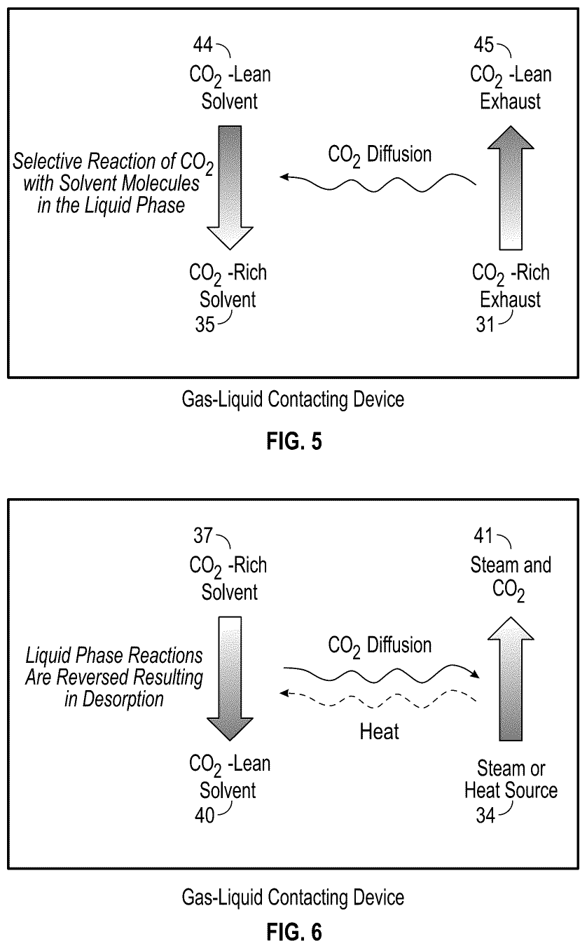

As mentioned above, circulation of the solvent occurs continuously so that the solvent is never saturated. Referring now to FIG. 5 and FIG. 6, schematics of the CO₂ absorption and solvent regeneration processes are shown, respectively. FIG. 5 shows a schematic of the CO₂ absorption process in a gas-liquid contacting device (such as absorber 33 in FIG. 4). As CO₂-rich exhaust 31 enters the gas-liquid contacting device, CO₂ diffuses into a liquid solvent capturing agent. Specifically, a CO₂-lean solvent 44 enters the absorber (in a countercurrent manner, relative to the exhaust), and as CO₂ diffuses from the gas to the liquid and reacts with the solvent, a CO₂-rich solvent 35 is shown. However, the CO₂ absorption is reversible and temperature dependent. At higher temperatures, the reverse of the CO₂ absorption reactions is favored. Thus, as shown in FIG. 6, which depicts a schematic view of the solvent regeneration process, when the CO₂ rich solvent 37 is heated up, such as by direct or indirect contact with steam or another heat source 34 in a gas-liquid contacting device (such as stripper 38 in FIG. 4), CO₂ and water vapor are released from the solvent (thereby forming CO₂-lean solvent 40).

The lean loading of the solvent depends on the rich loading, as well as the temperature and pressure of the regenerator. If insufficient heat is provided in the regenerator to maintain the target temperature at a given pressure, the solvent may not be completely regenerated resulting in a higher lean loading, which may prevent it from absorbing sufficient CO₂ in the absorber. In practice, the cyclic solvent capacity depends not only on the conditions of the regenerator, but also the concentration of CO₂ in the exhaust gas and the overall design of the absorber and regenerator stages of the process. Depending on the application, available heat, CO₂ concentration in the exhaust, available space, and other factors, a particular set of operating conditions may be determined to be optimal.

As described above, the solvent, including the at least two amino acids, rich in CO₂ enters the stripper, where water and CO₂ evaporate. It is also envisioned that in addition to the exhaust gas, the recirculated exhaust gas (also known as EGR, which is fed back into the engine, displacing some fresh air), which must be cooled, can provide additional heat to regenerate the solvent, whereby the hot CO₂-lean solvent from the stripper is pumped through an exhaust gas recirculation cooler, transferring heat from the recirculated exhaust gas to the CO₂-rich solvent before it is returned back to the stripper. Optionally, heat from the exhaust gas or the exhaust recirculation gas may be provided directly to the stripper via heat exchange surfaces, or indirectly by use of the exhaust gas to produce steam, which is then fed to the stripper. Other streams, such as the engine coolant or engine lubrication oil, may also be used. Extracted CO₂ and steam exit as gas from the stripper and the hot CO₂-lean is contacted with the cold CO₂-rich solvent in a heat exchanger, before passing through a trim cooler and returning to the absorber.

As mentioned, one or more embodiments of the present disclosure use a taurine and homotaurine solvent blend in the processes described above. The selection of the amino acid capturing agents in accordance with embodiments of the present disclosure involved consideration of eight different properties and the operating requirements, as a balance between the factors, including high CO₂ mass transfer, high heat of absorption (>70 KJ/mol CO₂), high cyclic capacity, low viscosity (ideally <8 cP), high solid solubility (no solids present under any normal operating conditions, i.e., across the loading and temperature range), low solvent toxicity, low process degradation rates (<2% per weck), high environmental degradation rates, and low volatility (ideally <10 ppm of VOC in the exiting exhaust gas).

High CO₂ mass transfer capability: N_{CO2}=Kₒᵥ * A * (P_{G,CO2}−P_{L,CO2}*) 1.

The flux of CO₂ into the solvent (N_{CO2}) is determined by the driving force (P_{G,CO2}−P_{L,CO2}*), the time available for absorption, the specific mass transfer area (A), and the overall mass transfer coefficient (Kₒᵥ).

50. While the time and area are primarily a function of the process design and equipment, the overall mass transfer coefficient is determined primarily by the solvent and only somewhat by the equipment. The overall mass transfer coefficient, which combines the gas and liquid side mass transfer coefficients, is expressed as Kₒᵥ, the liquid side mass transfer coefficient (k_{L}), or the reaction rate constant of one or more of the components with CO₂ (k₁). Sorbents with a high k₁ (for example in reaction 1 above shown for a generic primary amine), will have a high liquid-side mass transfer coefficient (k_{L}). As liquid-side mass transfer resistance is typically much greater than gas-side mass transfer for the types of CO₂ capture processes described, these solvents with high k_{L}, will in turn have a high Kₒᵥ. Thus, “fast” amines, which have a high reaction rate with CO₂ (k₁), will also have a high Kₒᵥ. Therefore, they will be able to absorb more CO₂ in a given amount of time and mass transfer area. For a given solvent, the CO₂ mass transfer coefficient is a function of loading due primarily to the fact that as the solvent is consumed, other reactions (reaction 2 above for instance) become more important. Furthermore, changes in physical properties, such as density and viscosity, will also change with CO₂ loading. These physical properties also affect the CO₂ mass transfer process. Changes in mass transfer rates as a function of loading can be complex. Phase change, in the case of solid precipitation of various products, also affects the loading and mass transfer behavior. Although the k₁ rate constant can be measured and is loosely correlated with pKa, the overall mass transfer rates of various sorbents, under relevant conditions (CO₂ loaded), cannot be predicted a priori and must be experimentally determined. Faster mass transfer rates are always preferred as they result in richer CO₂ loadings, lower solvent circulation rates, reduced pumping work, reduced sensible heat requirements, and smaller equipment size. For example, an acceptable solvent might facilitate a CO₂ flux of around 1×10⁻³ mol CO₂/s/m² from a gas stream containing 9% CO₂, in a membrane contactor, with a liquid over gas rate of around 4 kg per kg of gas, and with a superficial gas space velocity of around 0.5-1 s⁻¹. However, the exact flux will depend on the gas composition, equipment size, and selection of operating conditions.

High cyclic capacity: C(P_{CO2,lean}*)−C(P_{CO2,rich}*) 2.

The solvent capacity is defined as the difference in CO₂ concentration between the CO₂-lean- and CO₂-rich-loaded solutions. Therefore, it is a product of both the molar solvent concentration and the difference in the lean and rich loading. Solvents, which have a large difference between the lean and rich loading and relevant process conditions, will have a larger capacity, as will solvents that have a high mass solubility and low molecular weight. For solvents containing one nitrogen atom per molecule, a molecular weight of less than 200 is preferred in order to have a high capacity at reasonable solvent concentration. For higher molecular weight solvents, increasing mass concentration to compensate for high molecular weight may not be an option due to limitations of solubility, viscosity, cost, or degradation. Practical lean and rich loadings are a function of the inlet exhaust composition, target capture rate, solvent chemistry, equipment size, and operating parameters. Regarding solvent chemistry, the mass transfer coefficient (Kov, discussed above) will play an important role. However, the driving force for absorption will also play a role. This driving force can be expressed as the theoretical cyclic capacity, by determining the difference between the CO₂-lean and CO₂-rich loading under relevant equilibrium conditions. For example, for a process where the inlet exhaust gas CO₂ concentration is 9 kPa and the target capture rate is 40%, capacity could be defined as the difference between the CO₂ concentration in the liquid producing a CO₂ vapor pressure of 3 kPa and that producing a vapor pressure of 1 kPa. This ensures that the capacity is evaluated under conditions in which a driving force exists for mass transfer to occur both at the inlet and at the outlet of the absorber. Solvents with a higher cyclic capacity are always superior because they reduce the required solvent circulation rate, reducing sensible heat requirements, pumping work, and equipment size. For example, for a system in which 40% CO₂ removal is targeted from a stream containing 9% mol. of CO₂, a working capacity of around at least 0.2 mol CO₂ per kg of solvent may be preferred. Solvent capacity can also be related to rate since solvents with a faster rate will result in a richer rich loading all else being equal.

3. High heat of absorption can be related to the solubility of CO₂ in the solvent as a function of temperature via the Gibbs-Helmholtz relation:

$$\frac{\partial ( ln ( {P}_{CO 2} ) )}{\partial ( \frac{1}{T} )} = - Δ {H}_{abs} * R * T$$

Solvents with a higher heat of absorption produce a higher partial pressure of CO₂ at a given temperature. Since the temperature of the regeneration is limited by thermal degradation of the solvent, this means that for two solvents having the same propensity for thermal degradation rate (and thus the same regenerator temperature), the solvent with a higher heat of absorption will produce more CO₂ relative to steam in the stripper 28, reducing the stripper heat requirement and condenser cooling duty requirement. Since a large amount of the regeneration energy is used to produce steam, which is immediately condensed, solvents with higher heat of absorption will reduce the energy required for regeneration. Furthermore, solvents with a high heat of absorption will produce higher pressure CO₂, reducing expensive mechanical or electrical work required for CO₂ compression. For example, solvents with a high heat of absorption of around 70-85 KJ/mol of CO₂ is typical for some primary amines and amino acid solvents. Further, regeneration energy can be reduced compared with other solvents, such as some tertiary amines that have a heat of absorption around 40-60 KJ/mol.

4. Low volatility: volatile solvents can exit the system with the exhaust gas, causing secondary environmental problems and increasing solvent replacement rates. Water or acid washes might also be required to prevent emissions of volatile organic compounds. The cost of the water-wash can be very significant due to the large volume of the exhaust gas. Thus, non-volatile, or low-volatility solvents are always preferred, relative to high volatility solvents as the water-wash could be reduced in size or eliminated. Since only the “free” amine (not including amine molecules in protonated or carbamate form) can go to the gas phase, amine volatility is a strong function of the practical CO₂-lean loading. If a water wash is used, volatility is typically assessed under CO₂-lean and highly diluted conditions. Highly volatile solvents may produce exhaust gas exiting the absorber with several hundred parts per million (ppm) of evaporated solvent, whereas non-volatile solvents such as the alkali metal carbonate salts, alkali metal salts of amino and amino-sulfonic acids will produce no solvent constituents in the gas-phase of the exhaust due to their ionic nature. Non-volatile solvents also typically do not suffer from the very large solvent emissions sometimes occurring due to aerosol formation, as the solvent must typically first enter the gas phase before it can enter the aerosol particle. Membrane contactors also help reduce amine emissions from the absorber by preventing any emissions due to entrained liquid.

5. Low degradation rates: solvent degradation can occur in the absorber via oxygen available in the exhaust gas, dissolved oxygen in the solvent cross exchanger, reaction with metals that can cycle between an oxidized and reduced state (such as Fe²⁺ and Fe³⁺), thermal degradation (e.g. carbamate polymerization, or amide bond formation in the regenerator sump), or direct reaction with exhaust gas impurities (such as NO₂ and SO₂). This can lead to the formation of degradation products (which may be toxic or corrosive), loss of solvent capacity and system performance, and required solvent makeup. Corrosion can be synergistic with degradation as metals may catalyze oxidative degradation or act as oxygen carriers between the absorber and stripper. Solvents resistant to process degradation are always preferred. For example, stationary CO₂ capture systems employing a liquid solvent may target a degradation rate of 2% per week or lower. In particular, some amino acid solvents having both a primary, unhindered amino group as well as a carboxylic acid group are prone to very rapid degradation due to amide polymerization that can occur under typical regenerator conditions. Amino-sulfonic acids such as taurine and homotaurine do not experience this type of degradation due to the lack of a carboxyl group. Another important mechanism of degradation involves the dissolution of oxygen into the solvent in the absorber 23, which then reacts with the solvent in the cross exchanger 26 before the solvent enters the stripper 28. High ionic strength solvents, such as those containing amino acid salts are resistant to this type of degradation due to their lower oxygen solubility.

6. High solid solubility: for some solvents, a liquid solubility envelope exists outside of which solid precipitates can form. The envelope is a function of solvent concentration, CO₂ loading, and temperature at ambient pressure. Solids can cause problems with equipment clogging, which requires shutdown and servicing. Solid precipitation therefore limits the practical solvent concentration. Solvents should remain fully soluble under all conditions that are anticipated during operation, including startup and shutdown. For systems deployed on vehicles or remote locations the solvent should remain fully soluble under the anticipated environmental conditions for the application.

7. Low solvent toxicity: solvent toxicity can be a concern in case of a spill or other accidental release to the environment. Volatile or entrained solvent may be carried out of the system with the exhaust gas leaving the absorber. Solvents, which are non-toxic and do not persist in the environment, are always preferred, provided they do not also have high in-process degradation rates.

The present inventors have determined that amino acids present a balance between these properties and have a synergistic effect to achieve a capture rate of greater than 40% in a practical system for CO₂ capture from exhaust gas, while maintaining full solubility at room temperature and being non-volatile. In particular, embodiments of the present disclosure are directed to the combination of two or more amino acids. In one or more embodiments, the CO₂ capturing material or solvent includes a combination of two or more of the sodium or potassium salts of taurine, homotaurine, or N-methyl-taurine.

In one or more embodiments, each amino acid may be neutralized with an alkali metal hydroxide, such as sodium hydroxide, potassium hydroxide, or lithium hydroxide, to form the salt. The ratios moles of sodium or potassium or lithium hydroxide per mol of amino acid may range from 1:2 to 2:1. In one or more embodiments, each amino acid may be neutralized with an equimolar amount of potassium hydroxide. The amino acids may be combined with water to produce a solution with concentration of each amino acid in the range of 1-5 molality (m). In particular, for applications in which a membrane contactor is used to reduce the space required for the absorber, neutralized amino acid solutions may be preferable due to their high surface tension which reduces pore wetting and improves mass transfer in these types of gas contacting devices. For solvents utilizing two structurally similar amino acids, which have similar reaction rate with CO₂, capacity, and heat of absorption, a lower concentration of the less polar amino acid is preferable. This is due to two factors: (1) the mass transfer processes that occur in a membrane contactor can be highly susceptible to small amounts of pore wetting—the degree of which is dependent on the polarity of the solvent. This is because solvents with less polar constituents will typically have a lower surface tension and smaller contact angle between the solvent and the membrane contactor pore surface producing lower capillary pressure. This allows the solvent to penetrate further into the pore, creating a longer diffusion path and reducing the overall mass transfer coefficient; (2) the reduction in capacity for using a lower solvent concentration may be outweighed by the increase in solvent viscosity, which also reduces mass transfer, increases pumping work, and reduces heat transfer in the cross exchanger. In traditional packed column absorbers, surface tension is not a very important property and solvent viscosity has less (negative) impact on mass transfer due to the design of the column. However, in the highly compact hollow fiber membrane contactors used for mobile CO₂ capture, mass transfer was found to be highly dependent on surface tension and viscosity for the reasons mentioned above.

In one or more embodiments, the CO₂ liquid solvent capturing agent includes a blend of at least two amino- or amino-sulfonic acid salts, both present at 1 molal or greater concentration, and less than 5 molal concentration, and having a combined concentration of at least 3 molal. Typically, it is the zwitterionic form of the amino or amino-sulfonic acid that precipitates in CO₂ loaded solutions. However, the zwitterionic forms of amino or amino-sulfonic acid, which are structurally similar nonetheless, do not normally co-precipitate. Thus, the total solvent concentration can be increased while maintaining the concentration of each zwitterion in the loaded solution below the insolubility limit.

Amino-sulfonic acids may be preferred to amino acids because they cannot form amide condensation polymers and thus avoid undergoing rapid thermal degradation. Traditional amino acids which are hindered, such as secondary, or tertiary amino acids, are also much less likely to undergo amide polymerization than primary amino acids. Thus, in one or more embodiments, at least one of the at least two amino or amino-sulfonic acids is an amino-sulfonic acid, while in other embodiments, two amino-sulfonic acids may be used. In one or more embodiments, at least one of the amino-sulfonic acids may be a primary or secondary amino acid to provide a fast rate of reaction. The second amino-sulfonic acid may be highly soluble, or a hindered or tertiary amine having a high capacity. For example, a blend of 3 molal potassium taurinate, which would normally precipitate when in equilibrium with an exhaust stream containing a CO₂ concentration of 9 mol. %, can be kept in solution by addition of at least 1 molal of potassium homotaurinate, also known as 3-amino-propane sulfonic acid. Some of the homotaurinate can act as the generic base shown in reactions 1 and 2 and reduce the concentration of taurine zwitterion in CO₂-loaded solutions. Homotaurinate has the advantage of being highly soluble even when loaded with CO₂. However, it is less polar and has a lower surface tension than taurinate. Thus, a lower (or minimum) amount of homotaurinate may be preferred when the solvent is used with, for example, a membrane contactor where the CO₂ mass transfer is highly sensitive to the surface tension of the solvent and the contact angle between the solvent and the membrane contactor material. A similar effect may occur when adding potassium N-methyl-taurinate to a solution of potassium taurinate. An optimized blend may involve a mixture of all three constituents in order to maximize surface tension, CO₂ mass transfer, capacity, and solubility, while maintaining the advantageous properties of amino-sulfonic acids (non-volatility and very low-toxicity).

In embodiments, the blend is selected to be fully soluble under all operating conditions. For example, when the solution is left to equilibrate with CO₂ at concentration equal to that in the exhaust at the absorber 23 inlet, the solution must be optimized to avoid any precipitate. The viscosity of the solvent blend should be less than 10 cP to minimize pumping work and reduce heat and mass transfer resistance associated with high viscosity fluids. In one or more embodiments, the concentration of the least polar amino acids is minimized to the point of maintaining solubility under process conditions. For example, a solution of 3 m potassium taurinate in contact with an exhaust gas entering the absorber with 9 mol. % of CO₂, may require up to 1.5 molal of potassium homotaurinate or potassium n-methyl-taurinate to prevent precipitation from occurring. A solvent containing around 3 to 5 molal potassium taurinate and around 1 to 5 molal potassium homotaurine, or potassium n-methyl taurinate, has been shown to avoid precipitation under most operating conditions while avoiding pore wetting and maintaining high CO₂ mass transfer rates. In particular, a blend of 3 molal taurine with 1.5 molal homotaurinate, or N-methyl-taurinate, can avoid precipitation, maintain a fast reaction rate and CO₂ flux, avoid pore wetting, and maintain a low viscosity. A tertiary blend of N-methyl-taurinate, taurinate and homotaurinate shows promising results as well.

In these concentration ranges, a synergistic effect was found. Up to 5 molal of potassium taurinate is soluble as an unloaded solution. However, potassium taurinate begins to precipitate into solids when left in equilibrium with CO₂ at typical exhaust concentration of 5 to 12 mol. %. 5 molal of homotaurine is highly soluble with no precipitation at the limit of the test apparatus (−10° C.). Surprisingly, a blend of 3 molal of taurine and greater than 1.5 molal of homotaurine is highly soluble at room temperature including under CO₂ loaded conditions. The investigation showed that when 9 mol. % of CO₂ was injected into the liquid solvent capturing agent, 3 molal of potassium taurinate showed signs of precipitation, as did blends of 3 molal of potassium taurinate with 0.5 molal or 1 molal of potassium homotaurinate. However, blends of 3 molal potassium taurinate containing at least 1.5 molal of homotaurinate and up to at least 5 molal homotaurinate were fully soluble under loaded conditions and across the range of temperature expected in the process. Moreover, the present inventors also found that the physical properties of this blend facilitated high CO₂ mass transfer when used in a compact membrane contactor by having a high surface tension and reasonable viscosity, thus avoiding pore wetting, reducing solvent stagnation, and improving CO₂ mass transfer. In particular, surface tension is maximized by minimizing the amount of potassium homotaurinate in the solution required to maintain full solubility of the solvent. Traditional amine solvents, such as monoethanolamine and a blend of methyl-dicthanolamine and piperazine performed poorly in terms of CO₂ mass transfer due to their lower surface tension and propensity for porc wetting.

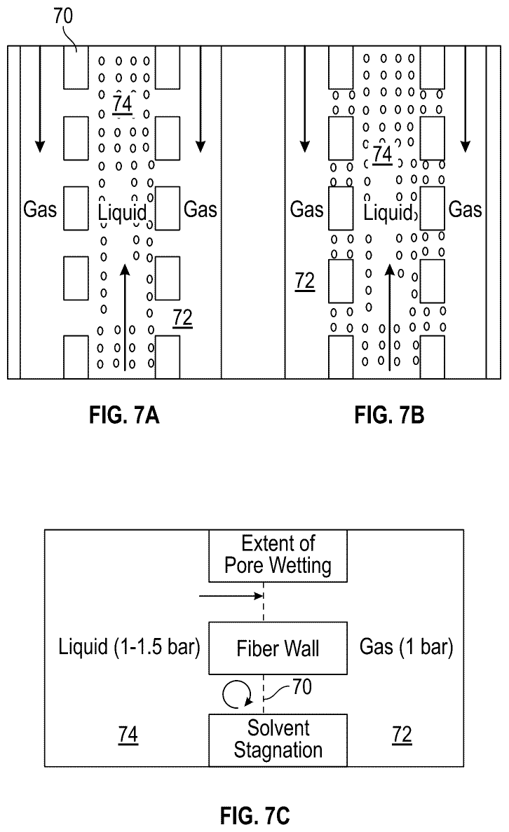

For example, FIG. 7A-B depicts a schematic view of the solvent/membrane/gas interfaces with a highly polar solvent on the left (FIG. 7A) and a less polar solvent on the right (FIG. 7B). The flow of liquid is opposite to the flow of gas. The membrane 70 is located at the interface between gas 72 and liquid phases 74. FIG. 7A shows the membrane 70 is non-wetted in presence of a highly polar solvent. FIG. 7B shows the membrane 70 is wetted with a less polar solvent. FIG. 7C is an enlargement of the membrane interface, wherein liquid 74 wets the pores of the membrane 70, where stagnant fluid slows down CO₂ gas permeation to the other side of the membrane 70.

Less polar molecules (those with a weaker dipole moment and lower ratio of charged or electro negative atoms such as oxygen and nitrogen to carbon atoms) have greater hydrophobicity and lower surface tension; thus producing a smaller contact angle between the solvent and the membrane material, which lowers capillary pressure, and resulting in a greater penetration of liquid into the membrane pore. For example, salts, including those of amino and amino sulfonic acids, are highly polar and have high surface tension due to the interaction of negative and positive ions in solution. It was found that amino acid salts with a greater number of non-polar hydrogen-carbon and carbon-carbon bonds will still have a lower surface tension despite the fact they are ionic in nature. This leads to greater pore wetting of the hydrophobic membrane, resulting in a stagnation, less convective mass transfer in the liquid boundary layer, a longer diffusion path for CO₂ molecules in the gas to reach the bulk liquid at the end of the pore as shown in FIG. 7B, and ultimately a lower overall CO₂ mass transfer coefficient. A typical diffusion coefficient for a molecule in the gas phase is in the range of 10⁻⁶ to 10⁻⁵ m²/s. By contrast, diffusion for molecules dissolved in liquids is far slower. In an aqueous solution, typical diffusion coefficients are in the range of 10⁻¹⁰ to 10⁻⁹ m²/s. Therefore, diffusion rates are much slower in the wetted pores of the membrane than in the gas phase of the membrane (in the non-wetted case) leading to lower overall mass transfer rates, less CO₂ flux, and lower capture rates.

More viscous solvents (those with a higher molar concentration of solvent, or those with a higher molecular weight) may result in less turbulent flow and less momentum-driven mixing in the pores. As some amount of pore wetting will likely occur in any solvent, the reduction in turbulence with higher viscosity solvents will reduce mass transfer rates through the liquid in the pores. Typically, a viscosity range of 1 cP to 8 cP may be used, with a viscosity of 5 cP or less being preferred. A solvent concentration of about 20-40 wt. % of solvent in water (in the unloaded solution) may be used in order to have sufficient capacity with reasonable viscosity.

Higher viscosity solvents will also produce more pressure drop across the membrane contactor 70, resulting in higher inlet pressures on the liquid side 74 and a greater pressure difference between the liquid 74 and the gas side 72. This higher pressure will push more liquid into the pores, again decreasing the rate of mass transfer.

Although physical interactions between different absorption liquids and contactors are known and characterized, the magnitude of the effect was surprising to the present inventors. For membrane contactors used for capturing carbon dioxide from mobile sources (where the high specific area of membrane contactors is strongly preferred), the physical properties of the solvent were found to be at least as important, if not more important, than the chemical properties (reaction rate constants, vapor liquid equilibrium, and practical CO₂ loading). In traditional applications for stationary CO₂ capture, physical properties play a relatively minor role in determining the overall mass transfer coefficient or effective area. In contrast, in the present systems, the liquid physical properties were found to be dominant. For example, piperazine has a very fast rate of reaction with CO₂ allowing it to be used as a promoter of slower solvents such as methyldiethanolamine (MDEA), monoethanolamine (MEA), and 2-amino-2-methyl-1-propanol (AMP) in stationary applications. However, piperazine-promoted MDEA had a lower capture rate than slower MEA due to the offsetting effects of the physical properties (higher viscosity and lower surface tension).

The presently described amino acid solvents are particularly suited for the mobile carbon capture application—such as when using a high specific surface area contactor, which is not gravity driven—to accommodate space and packaging constraints. Thus, in addition to the benefits of non-volatility, low-toxicity, and resistance to oxidative degradation, amino acid solvents may also have favorable interaction with membrane contactors—due to their high polarity and high surface tension, which reduces pore wetting, and due to their lower viscosity than other advanced amine solvents.

### EXAMPLES

### Example 1

Amino acid solvents were selected for evaluation as they can match the capture rates and the thermodynamic performance of first-generation solvents (such as ethanolamine, diethanolamine, and 2-amino-2-methyl propanol). Further, amino acid solvents are non-toxic, more resistant to oxidative degradation and have no volatility issue being salts.

Table 1 below is a summary of the candidate amino acids considered for use in small-scale and mobile carbon capture processes. Some of these molecules were selected for solubility testing or testing in a small pilot plant as discussed below.

TABLE 1

| Structure/ | CAS | | | |
|---|---|---|---|---|
| Concentration | No. | Name | Pros | Cons |
| 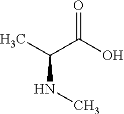 | 3913- 67-5 | N-methyl- alanine | High cyclic capacity, resistant to amide bond formation | Low capacity |
| 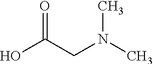 | | dimethylamino acetic acid | High cyclic capacity | Slow reaction rate, very low heat of absorption |
| 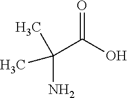 | 62-57-7 | 2-amino- isobutyric acid | Fast reaction rate, very resistant to amide bond formation, high heat of absorption | Low solubility |
| 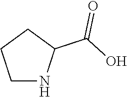 | | proline | Very high solubility, fast reaction rate at very lean loading | Slow reaction rate at high loading, high molar mass and viscosity, low capacity |
| 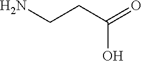 | | beta alanine | High heat of absorption, fast reaction rate, good solubility | Susceptible to amide bond formation and degradation, low heat of absorption |
| 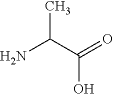 | | alpha alanine | Fast reaction rate, high heat of absorption | Low solubility |
| 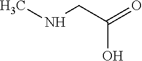 | | sarcosine | High solubility, fast reaction rate, good capacity | Low heat of absorption |
| 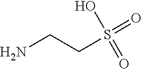 | | taurine | Fast reaction rate, high heat of absorption, no amide bond formation | Low solubility at optimal loading, low capacity |
| 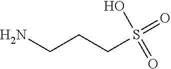 | | homotaurine | High solubility, no amide bond formation | Slow reaction rate, low capacity |
| 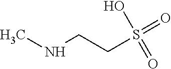 | | n-methyl-taurine | High solubility, no amide bond formation | Low capacity, moderate heat of absorption |

N-methyl-alanine was not tested due to its low capacity. Dimethylamino acetic acid was not tested because it is a tertiary amine. Therefore, the candidate amino acids selected for solubility testing were 2-amino-isobutyric acid, proline, beta-alanine, alpha-alanine, sarcosine, taurine, homotaurine, and n-methyl-taurine.

Preliminary solubility testing was carried out with various amino and amino-sulfonic acids and blends thereof to determine the propensity for solids precipitation. These blends were loaded with CO₂ under representative process conditions: a CO₂ loading from 0.35 to 0.45 mol CO₂/mol alkalinity at ambient pressure and a temperature from −10° C. to 40° C. CO₂ loading was achieved by addition of potassium bicarbonate instead of some potassium hydroxide as the neutralizing agent. The loading (in mol CO₂ per mol alkalinity) was determined from the following equation:

$$loading = \frac{{C}_{KHCO 3}}{{C}_{KHCO 3} + {C}_{KOH}}$$

$${C}_{amino acid} = {C}_{K} = {C}_{KHCO 3} + {C}_{KOH}$$

Table 2 is a summary of the results on precipitation:

TABLE 2

| Taurine | Homotaurine | Loading | Precipitation |
|---|---|---|---|
| Concentration | Concentration | (mol CO₂/ | Temperature |
| (m) | (m) | mol alk.) | (° C.) |
| 3 | 0 | 0.35 | 13 |
| 3 | 0 | 0.40 | 31 |
| 3 | 0 | 0.45 | 37 |
| 0 | 5 | 0.35 | <−10 |
| 0 | 5 | 0.40 | <−10 |
| 0 | 5 | 0.45 | <−10 |
| 3 | 5 | 0.35 | <−10 |
| 3 | 5 | 0.40 | <−10 |
| 3 | 5 | 0.45 | <−10 |
| 3 | 3 | 0.35 | <−10 |
| 3 | 3 | 0.40 | <−10 |
| 3 | 3 | 0.45 | <−10 |
| 5 | 3 | 0.35 | −10 |
| 5 | 3 | 0.40 | 0 |
| 5 | 3 | 0.45 | >40 |

CO₂-loaded in 3 molal of taurine was found to be soluble at process temperatures from 40° C. to 120° C., but potentially not soluble at room temperature (depending on loading). However, the vehicle will be at room temperature for a long time after the engine is turned off. Therefore, room temperature solubility is one of the requirements.

5 molal of homotaurine was found to be highly soluble with no precipitation at the lowest limit of the test apparatus (−10° C.). Surprisingly, a blend of 3 molal of taurine and 5 molal of homotaurine was found to be highly soluble. Homotaurine helps solubilize taurine and keep it in solution. This may be due to preferential protonation of homotaurinate over taurinate in the presence of CO₂, resulting in lower concentrations of the taurine zwitterion, which is the most likely constituent to form a precipitate in the loaded taurine solution. This synergistic effect may significantly increase the amount of dissolved CO₂ in the capturing solvent.

### Example 2

To evaluate the solutions in a continuous flow apparatus, the amino acid was mixed with water at a target concentration. As solubility was found to be highly sensitive to loading, additional solubility testing was carried out using a pre-determined concentration of CO₂ in the gas as opposed to targeting a specific loading. This allowed for a systematic analysis of this limitation of amino acid solvents using a specifically developed screening test. Another benefit was that molecules could be quickly and easily screened without requiring a large amount of material.

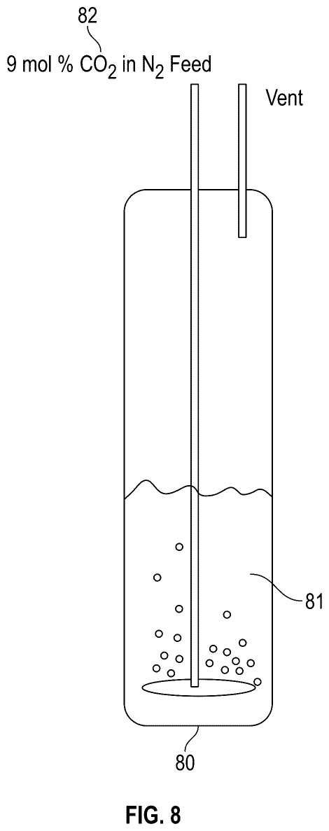

Referring now to FIG. 8, the CO₂ capturing liquid mixtures 81 were tested in a gas sparger 80 according to the following procedure. For amino acid solvents, an equimolar amount of potassium hydroxide was added such that the molar ratio of potassium to acidic carboxylate or sulfonate functional groups in the mixture was equal. The mixture of water, potassium hydroxide, and amino acid was stirred until all solids had dissolved.

The most promising amine solvents identified from the literature were mixed with water in the gas sparger 80. The continuity of the process was simulated by continuously sparging 9 mol % CO₂ in N₂ gas 82 into the CO₂ capturing liquid mixtures 81. 9 mol % CO₂ was selected as it is representative of the CO₂ concentration at a typical mid-load operating point in a heavy-duty truck. Weight of the solution was measured periodically to determine CO₂ uptake. After sparging N₂ and CO₂ gas mixture for up to 72 hours at a specified temperature and pressure, the gas flow was stopped, and any precipitation recorded. The test was stopped if solids were formed or if the solution mass stopped changing (i.e., the solution remained soluble when fully loaded with CO₂). After completion, the testing apparatus 80 was drained, flushed twice with deionized water, drained again, and then filled with the next solvent.

Complete equilibration between the gas and liquid represents a worst-case scenario from a solubility standpoint. Therefore, the solubility test allowed for the maximum soluble concentration of the fully loaded amino acid solvent to be determined. Thus, only the optimum solvent concentrations are then tested in the larger apparatus. Nine individual amino acid solvents were tested in accordance with the details described above: amino isobutyric acid, proline, sarcosine, beta alanine, n-methyl-taurine, n-methyl-alanine, alpha alanine, taurine, and homotaurine as described in Table 3 below, which summarizes solubility testing of amino acid solvents in the gas bubbler of FIG. 8 at 22° C. in equilibrium with 9 mol % CO₂ 82.

TABLE 3

| | | Molar | | | Molar | | |
|---|---|---|---|---|---|---|---|
| | | Mass (1) | Conc. (1) | | Mass (2) | Conc. (2) | |
| Sample | Amino Acid (1) | in g/mol | in m | Amino Acid (2) | in g/mol | in m | Soluble |
| 3 m AlBA | Amino isobutyric acid | 103.12 | 3 | | | | NO |
| 2 m AlBA | Amino isobutyric acid | 103.12 | 2 | | | | NO |
| 1 m AlBA | Amino isobutyric acid | 103.12 | 1 | | | | YES |
| 5 m PRO | Proline | 115.13 | 5 | | | | YES |
| 3 m PRO | Proline | 115.13 | 3 | | | | YES |
| 5 m SAR | Sarcosine | 89.093 | 5 | | | | YES |
| 3 m SAR | Sarcosine | 89.093 | 3 | | | | YES |
| 5 m b-ALA | Beta-alanine | 89.09 | 5 | | | | YES |
| 5 m NMT | n-methyl-taurine | 139.18 | 5 | | | | NO |
| 3 m NMT | n-methyl-taurine | 139.18 | 3 | | | | YES |
| 3 m NMA | n-methyl-alanine | 103.12 | 3 | | | | YES |
| 5 m NMA | n-methyl-alanine | 103.12 | 5 | | | | NO |
| 3 m a-ALA | Alpha-alanine | 89.09 | 3 | | | | NO |
| 3 m TAU | taurine | 125.15 | 3 | | | | NO |
| 5 m TAU | taurine | 125.15 | 5 | | | | NO |
| 3 m HTAU | homotaurine | 139.17 | 3 | | | | YES |
| 3 m TAU + | taurine | 125.15 | 3 | homotaurine | 139.17 | 5 | YES |
| 5 m HTAU | | | | | | | |
| 3 m TAU + | taurine | 125.15 | 3 | homotaurine | 139.17 | 0.5 | NO |
| 0.5 m HTAU | | | | | | | |
| 3 m TAU + | taurine | 125.15 | 3 | homotaurine | 139.17 | 1 | NO |
| 1 m HTAU | | | | | | | |
| 3 m TAU + | taurine | 125.15 | 3 | homotaurine | 139.17 | 1.5 | NO |
| 1.5 m HTAU | | | | | | | |
| 3 m TAU + | taurine | 125.15 | 3 | homotaurine | 139.17 | 2 | YES |
| 2 m HTAU | | | | | | | |
| 3 m TAU + | taurine | 125.15 | 3 | homotaurine | 139.17 | 3 | YES |
| 3 m HTAU | | | | | | | |
| 1.7 m TAU + | taurine | 125.15 | 1.7 | homotaurine | 139.17 | 1.7 | YES |
| 1.7 m HTAU | | | | | | | |
| 2.5 m TAU + | taurine | 125.15 | 2.5 | homotaurine | 139.17 | 1.7 | YES |
| 1.7 m HTAU | | | | | | | |

Out of these 9 amino acid solvents, 1 molal (m) amino isobutyric acid, 3-5 m proline, 3-5m sarcosine, 5 m beta alanine, 3 m n-methyl-taurine, 3 m n-methyl-alanine, 3 m homotaurine, and the combinations of 1.7-3 m taurine with 1.7-5 m homotaurine did not precipitate when 9 mol % CO₂ was continuously injected in ambient conditions. Therefore, the most promising amino acid solvents were tested using the same procedure and apparatus described in Example 2. The solvents were tested at 210 kPa stripper pressure, 120° C. stripper temperature, 3.75 kg/min liquid circulation rate, 9 mol % CO₂ in the gas fed into the solvent at 25 standard cubic feet per minute (SCFM) gas rate and the results summarized in Table 4 below.

TABLE 4

| Composition | Capture rate (%) | Solid Observed |
|---|---|---|
| 3 m taurine | 45 | YES |
| 5 m taurine | 57 | YES |
| 3 m taurine + 1.5 m homotaurine | 38 | NO |
| 3 m taurine + 5 m homotaurine | 23 | NO |
| 3 m proline | 7 | NO |
| 5 m proline | 6 | NO |
| 5 m beta alanine | 15 | NO |
| 5 m sarcosine | 21 | NO |
| 3 m sarcosine | 21 | NO |

Although potassium proline, beta alanine, and sarcosine solutions are all soluble under process conditions, they also show lower capture rates than the taurine and homotaurine blends that were fully soluble with continuous injection of CO₂. None of the structures tested performed as well in terms of capture rate and solubility as the taurine and homotaurine blends. Therefore, these blends of taurine and homotaurine were selected for the next set of experiments in conditions closer to the final application.

### Example 4

A test plant was designed as a continuously operating process plant with propane burner to generate exhaust, membrane contactor to absorb CO₂ from the exhaust, and electric boiler filled with random packing to regenerate the solvent and strip out the CO₂. The standard exhaust conditions at the inlet to the membrane contactor were 25 SCFM, 9 mol % CO₂, 40° C., and 1-1.1 bar absolute pressure. The gas rate of 25 SCFM was approximately 1/16 of that expected from the engine of a full size, class 8 semi-truck operating at the mid-speed and mid-load cruise (known as B50) operating point.

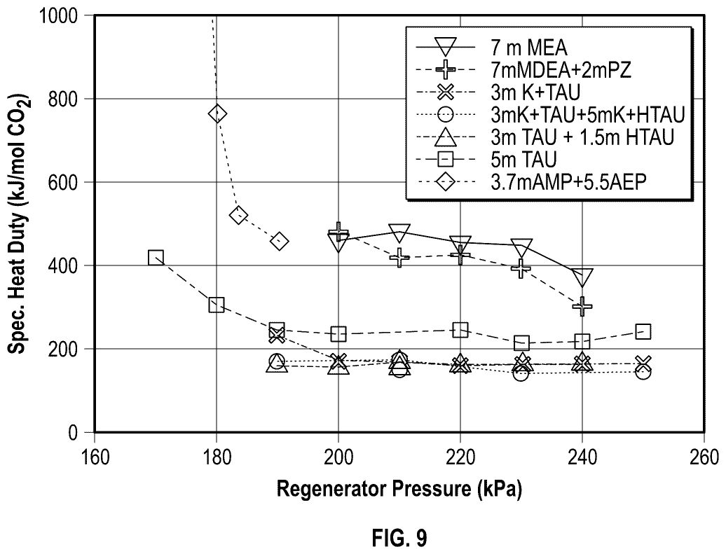

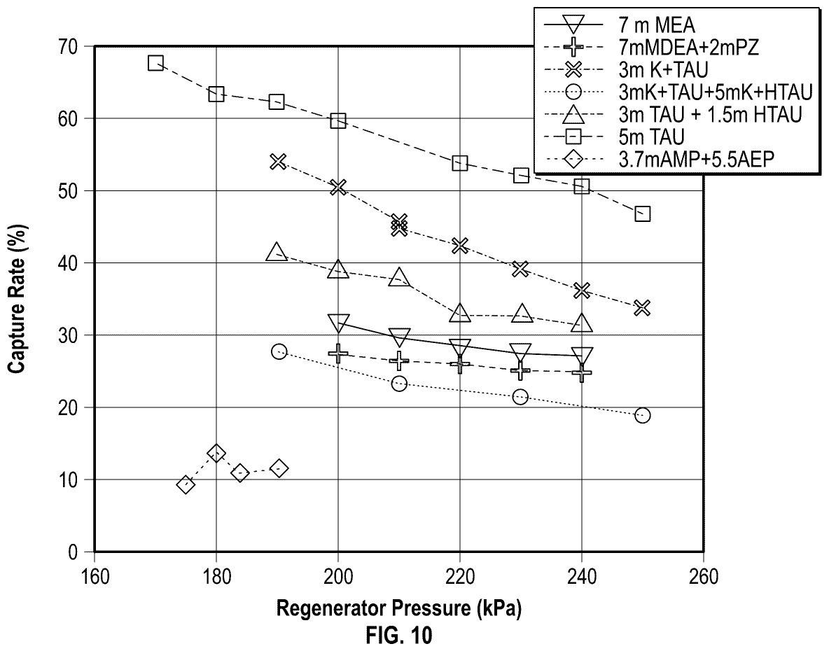

Benchmark solvent testing was conducted on four standard amine solvents used for CO₂ capture for stationary applications. FIG. 9 shows a diagram of the specific heat requirements for regeneration of selected amino sulfonic acid blends, traditional amines, and amine blends as a function of regeneration pressure. FIG. 10 is a diagram of the percentage of CO₂ capture rates for selected amino sulfonic acid blends, traditional amines, and amine blends as a function of regeneration pressure.

A solvent containing 7 m of monoethanolamine (MEA) is represented as an upside-down triangle in FIG. 9 and FIG. 10. MEA is a common solvent used for stationary CO₂ capture systems.

A solvent containing a blend of 7 m of methyldiethanolamine (MDEA) mixed with 2 m of piperazine (PZ) is represented in plus sign in FIG. 9 and FIG. 10. This is an example of an advanced solvent for stationary CO₂ capture systems and acid gas treating applications. It has more resistance to degradation, an improved reaction rate, and CO₂ capture capacity compared to MEA.

A solvent containing 3 m of potassium taurinate (K+TAU) is in cross in FIG. 9 and FIG. 10.

A solvent containing 3 m of potassium taurinate (K+TAU) and 5 m of potassium homotaurinate (K+HTAU) is represented with circles in FIG. 9 and FIG. 10.

A solvent containing 3 m of taurine (TAU) and 1.5 m of homotaurine (HTAU) is represented with triangles in FIG. 9 and FIG. 10.

A solvent containing 5 m of taurine (TAU) is represented with squares in FIG. 9 and FIG. 10.

A solvent containing 3.7 m of 2-amino-2-methyl-1-propanol (AMP) mixed with 5.5 m of N-aminoethyl-piperazine (AEP) is represented with diamonds in FIG. 9 and FIG. 10. This is an example of an advanced solvent with fast rate of reaction and high capacity to store CO₂.

Each solvent was tested at a liquid circulation rate of 3.75 kg/min, and stripper pressures ranging from 180 kPa to 250 kPa. At constant stripper temperature, higher stripper pressure always increases the lean loading, which decreases the driving force for CO₂ absorption and thus the capture rate in the absorber. Therefore, solvents showing low capture rates at low stripper pressure were not tested at higher pressures. Test conditions are summarized in Table 5 below.

TABLE 5

| Parameter | Value |
|---|---|
| Specific gas rate (SCFM per contactor) | 25 |
| CO₂ concentration (mol %) | 9 |
| Liquid rate per contactor (kg/min per contactor) | 3.75 |
| Liquid/Gas (mass basis) | 4.1 |
| Absorber liquid inlet temperature (° C.) | 40 |
| Absorber pressure (atm) | 1 |
| Stripper temperature (° C.) | 120 |
| Stripper pressure (kPa) | 175-250 (sweep) |

Turning to FIG. 9 now, every solvent tested meets the requirement of regeneration heat rate of less than 6 MJ/kg of CO₂. The heat rate required for regeneration is the amount of heat energy used by the stripper to regenerate the solvent divided by the number of moles of CO₂ captured. For instance, the solvent containing 3.7 m of 2-amino-2-methyl-1-propanal (AMP) mixed with 5.5 m of N-aminoethyl-piperazine (AEP) needed the most amount of regeneration heat rate with 450 to 775 KJ/kg of CO₂ under a pressure in between 200 and 180 kPa, respectively. On the other hand, the solvent containing 3 m of taurine (TAU) and 1.5 m of homotaurine (HTAU) needed the least amount of regeneration heat rate with 180 KJ/kg of CO₂ under a pressure in between 240 and 200 kPa. Therefore, the traditional solvents did not show any advantage in term of specific heat rates. Furthermore, heat requirements are less important for mobile carbon capture systems as ample, high quality waste heat is often available in the exhaust for regenerating the solvent.

However, these traditional solvents, tested for benchmarking purposes, showed poor results in term of CO₂ capture rates with rates below 40%, which is below the target rate as shown in FIG. 10. This result of low capture rates for the benchmark solvents was surprising. Specifically, the solvent containing 7 m of methyldiethanolamine (MDEA) mixed with 2 m of piperazine (PZ) and the solvent containing 2-amino-2-methyl-1-propanol (AMP) mixed with 5.5 m of N-aminoethyl-piperazine (AEP) show poor performance relative to the solvent containing 7 m of monoethanolamine (MEA). Based on the test data, it was hypothesized that a strong interaction exists between the membrane contactor and the solvent, which significantly affects the mass transfer process in the absorber.

The selected amino acid solvents, on the other hand, show CO₂ capture rates up to 70%. Specifically, the solvent containing 5 m taurine exhibits CO₂ capture rates from almost 50% at 250 kPa to almost 70% at 170 kPa. However, solids are observed at atmospheric pressure and room temperature, as shown in Table 4 above, preventing its use alone in transportation applications. The solvent containing 3 m potassium taurinate shows CO₂ capture rates from 35% at 250 kPa to almost 55% at 170 kPa. However, solids are formed in ambient conditions as well.

In contrast, the solvent containing 3 m taurinate mixed with 1.5 m of homotaurine does not have this solubility issue and exhibits CO₂ capture rates from 30% at 250 kPa to 40% at 170 kPa. Therefore, this amino acid solvent meets the capture rate requirement at 170 kPa. However, if the concentration of potassium homotaurinate is increased to 5 m while the concentration of potassium taurinate is kept at 3 m, the capture rates are well below the 40% requirement from 250 kPa to 170 kPa.

In summary, every solvent tested meets the requirement of regeneration heat rate of less than 6 MJ/kg of CO₂ to achieve 40% CO₂ capture for an engine with 9% CO₂ in the exhaust and 80 KW of available waste heat. However, not every solvent was able to achieve the desired capture rate of 40% under the test conditions. The solvent containing 3 m taurinate mixed with 1.5 m of homotaurine not only exceeds the capture rate and regeneration heat requirements, meaning that some heat is left over for power generation or capturing additional CO₂, but it is the only solvent tested capable of also simultaneously meeting the CO₂ capture rate and solubility requirements as well. In addition, it has the lowest specific heat rates, meaning that additional heat can be available for power generation or to increase the capture rate beyond 40%.

While the scope of the composition and method will be described with several embodiments, it is understood that one of ordinary skill in the relevant art will appreciate that many examples, variations and alterations to the composition and methods described here are within the scope and spirit of the disclosure. Accordingly, the embodiments described are set forth without any loss of generality, and without imposing limitations, on the disclosure. Those of skill in the art understand that the scope includes all possible combinations and uses of particular features described in the specifications.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. A method of capturing CO₂, comprising:
separating CO₂ from exhaust gas by absorption in an absorption zone comprising a liquid solvent partitioned from the exhaust gas by a liquid gas contactor that is a porous membrane contactor;
wherein the liquid solvent comprises a blend of alkali metal salts of two or more of an amino acid or an amino sulfonic acid;
wherein a ratio of total alkali metal to total carboxylate or sulfonate functional groups on the amino acid or the amino sulfonic acid is between 2:1 and 1:2;
wherein a first constituent is a primary or secondary amino acid or a secondary amino sulfonic acid with molar mass of less than 200 g/mol and is present at a concentration of 2 to 5 molality (m);
wherein a second constituent is selected from the group consisting of primary amino sulfonic acid salts, secondary amino acids, secondary amino sulfonic acid salts, tertiary amino acid, and tertiary amino sulfonic acid salts, and has a molar mass of less than 300 g/mol and is present at a concentration of 0.5 to 5 m;
wherein the total concentration of the amino acid salt and the amino sulfonic acid salt in the solution is at least 3 m and less than 10 m; and
wherein a concentration of a least polar amino acid salt or a least polar amino sulfonic acid salt is less than the other salt, and
regenerating the liquid solvent rich in CO₂ in a regeneration zone using heat generated by the internal combustion engine, thereby releasing CO₂ from the liquid solvent.

16. The method of claim 15, wherein the method of capturing CO₂ is performed on-board of a mobile source powered by an internal combustion engine.

17. (canceled)

18. The method of claim 15, further comprising: compressing the CO₂ released from the liquid solvent, thereby increasing the density of the captured CO₂ for temporary on-board storage.

19. The method of claim 16, further comprising: converting the internal combustion engine waste heat into electrical power or mechanical work.

20. The method of claim 15, further comprising:
passing the regenerated liquid solvent to the absorption zone; and
absorbing CO₂ from exhaust gas in the absorption zone with the regenerated liquid solvent, thereby forming a continuous regenerative system.

21. The method of claim 15, further comprising: retrofitting a mobile source to include an on-board CO₂ capture and storage system that performs the separating and releasing of CO₂.

22. The method of claim 15, wherein the porous membrane contactor is constructed from ether ketone, polypropylene, polyethylene, polyether polytetrafluoroethylene, or other polymeric material.

23. The method of claim 15, wherein the membrane contactor consists of a bundle of porous fibers having an internal diameter of 10-500 μm and a pore size of 10-200nm, and in which the liquid solvent is passed through the inside of the fibers, the gas is passed around the outside of the fibers, and in which gases freely diffuse through the pores of the fibers but liquid is retained inside the fibers.
